(19) United States
(12) Patent Application Publication
(10) Pub. No.: US 2012/0304585 A1
(43) Pub. Date: Dec. 6, 2012

(54) VISION PANEL ASSEMBLY MOUNTED IN A TWIN SHEET DOOR OR WINDOW AND METHOD OF INSTALLATION

(76) Inventor: Abdul Majid Aboobaker Coatwala, Mumbai (IN)

(21) Appl. No.: 13/577,211

(22) PCT Filed: Jan. 18, 2011
(86) PCT No.: PCT/IN2011/000038

§ 371 Date: Aug. 3, 2012

(30) Foreign Application Priority Data
Feb. 3, 2010 (IN) 282/MUM/2010

(51) Int. Cl. E04C 2/38; E06B 1/56; E06B 1/04

(52) U.S. Cl. 52/656.2; 52/745.15

(57) ABSTRACT

The Invention relates to Vision Panel Assembly for a twin sheet door/window and a method of installation. The vision panel assembly comprises of a frame, brackets, a vision panel and securing means for fastening the vision panel assembly. In one embodiment of the invention the vision panel is installed equidistant from either sheet of the twin sheet door/window. In a second embodiment the vision panel is installed to one side of the vision panel assembly to rest against the cutout in the Outside sheet of the twin sheet door/window. The method of installing the vision panel assembly comprises the steps of making cutouts of equal or unequal dimensions on both sheets of the door/window, fixing the frame members onto the inner surface of the sheets of the twin sheet door/window to form the frame and securing the vision panel into position in the frame with the help of brackets which are fastened into the frame using securing means.

### FIELD OF THE INVENTION

This invention relates to a Vision Panel Assembly and the Method of installing it. This vision panel assembly is mounted in a twin sheet door or window.

### THE BACKGROUND OF INVENTION

The Invention relates to Vision Panel Assembly for a twin sheet door/window and a method of installation.

Conventional Door/Window Vision Panels are manufactured in two parts, that is, a pair of brackets to be fitted on both sheets of the door/window. The vision panel is sandwiched between both these brackets at the time of installation. The brackets are separately manufactured and transported to the site where installation has to take place, whereby chances of damage to the parts increases. Damaged parts would directly lead to the dislodgement of the vision panel assembly thus jeopardizing its safety and security.

Conventional vision panel brackets are installed on the surface of the sheets of the door/window creating a protrusion on the surface of the sheets of the door/window. These conventional vision panel brackets have transportation and storage problems. They are to be transported separately and can not be factory fitted into the door/window. If they were factory fitted into the door/window, due to the protrusion on the door/window, the doors/windows could damage one another, if stacked together. This also leads to storage problems. Additionally since the vision panel brackets are not factory fitted, there is a chance of misplacement of the brackets at the site.

Conventional Door/Window Vision Panels put a restriction on the size of the vision panel. That is, the bigger the size of the vision panel, the more difficult the manufacture and installation of the vision panel assembly. Due to the length of the vision panel brackets there may be a chance of missing the alignment with the door/window and it also reduces the strength of fitment from the point of view of security and safety of the vision panel assembly.

Conventional Door/Window Vision Panels are manufactured involving complex procedure leading to increased cost of production and increased production time. Additionally the installation procedure can be done by skilled people only. Also complexity of manufacture and installation makes maintenance and repair that much more difficult.

### OBJECT OF THE INVENTION

Accordingly, it is a primary object of this invention to provide a vision panel assembly and a method of installing it, which obviates the deficiencies associated with the prior art.

It is another object of this invention to provide a vision panel assembly that can be installed in a door/window of any thickness.

It is yet another object of this invention to provide a vision panel assembly that is simple in construction, easy to assemble and has low manufacturing costs.

It is yet a further object of this invention to provide a vision panel assembly where damage to the brackets before installation can be avoided thereby increasing safety and security. This can be done by manufacturing the frame members and the brackets as easy to assemble parts which can be easily put together to form the vision panel assembly.

It is another object of this invention to provide a vision panel assembly which when factory fitted into the twin sheet door/window does not create transportation or storage problems.

It is yet another object of this invention to provide a vision panel assembly whose brackets do not create a protrusion on the plain surface of the door/window.

It is also an object of this invention to provide a vision panel assembly which has brackets of which only the angled side is on display and the other sides are hidden from view thus giving it an aesthetic look.

It is another object of this invention to provide a vision panel assembly which has ease of manufacture and installation even with increased size of the brackets.

It is also an object of this invention to provide a vision panel assembly which provides security and safety even with increased size of the brackets.

It is a further object of this invention to provide a vision panel assembly in which the vision panel can be extracted easily, in case it breaks, thus ensuring ease of maintenance and repair.

It is another object of the invention to provide a vision panel assembly which can be easily assembled by an unskilled person.

It is a yet another object of this invention to provide a vision panel assembly that can be installed to one side of the assembly. This will ensure ease of cleaning since only one side of the assembly will need to be cleaned.

It is yet a further object of this invention to provide a vision panel assembly which is robust and secure.

### STATEMENT OF THE INVENTION

Accordingly to achieve the above mentioned objects, the present invention provides:

A vision panel assembly mounted in a cutout in a twin-sheet door or window comprising:
a frame adapted to be mounted in the said cutout comprising of:
   side frame members disposed along the side peripheries of the said cutout; and
   top and bottom frame members disposed along the top and bottom periphery of the said cutout;
brackets adapted to be mounted in the said frame including:
   a top and a bottom inside bracket;
   a top and a bottom outside bracket;
   two inside side brackets and;
   two outside side brackets;
a vision panel disposed in the said frame and;
securing means to fasten the vision panel assembly and provide a tamper-proof arrangement.

A method of installing the vision panel assembly comprising the steps of:
Making cutouts of the desired shape of equal or unequal dimensions on both sheets of the twin sheet door/window;
Securing the frame, brackets and vision panel into position.

### THE SUMMARY OF THE INVENTION

The Invention relates to Vision Panel Assembly for a twin sheet door/window and a method of installation. The vision panel assembly comprises of a frame, brackets, a vision panel and securing means for fastening the vision panel assembly. In one embodiment of the invention the vision panel is installed equidistant from either sheet of the twin sheet door/window. In a second embodiment the vision panel is installed to one side of the vision panel assembly to rest against the cutout in the Outside sheet of the twin sheet door/window. The method of installing the vision panel assembly comprises the steps of making cutouts of equal or unequal dimensions on both sheets of the door/window, fixing the frame members onto the inner surface of the sheets of the twin sheet door/window to form the frame and securing the vision panel into position in the frame with the help of brackets which are fastened into the frame using securing means.

### BRIEF DESCRIPTION OF THE DRAWINGS

FIG. 1 depicts the Front view of the Side Frame member 1 of Embodiment I.

FIG. 2 depicts the Front view of the Top and Bottom Frame members 4 of Embodiment 1.

FIG. 3 depicts the Front view of the Inside and outside side bracket 9 of Embodiment I.

FIG. 4 depicts the Front view of the Top and Bottom Outside Bracket 13 of Embodiment I.

FIG. 5 depicts the Front view of the Top and Bottom Inside Bracket 20 of Embodiment I.

FIG. 6 depicts the inside sheet 27 of the twin sheet door/window with the Vision Panel installed of Embodiment I.

FIG. 7 depicts the Outside sheet 29 of the twin sheet door/window with the Vision Panel installed of Embodiment I.

FIG. 8 depicts the top view of the Horizontal Cross Section of the Vision Panel Assembly of Embodiment I.

FIG. 9 depicts the side view of Vertical Cross Section of the Vision Panel Assembly of Embodiment I.

FIG. 10 depicts the Front view of the Top and Bottom Frame member 31 of Embodiment II.

FIG. 11 depicts the Front view of the Inside side bracket 35 of Embodiment II

FIG. 12 depicts the Front view of the Top and Bottom Inside Bracket 39 of Embodiment II

FIG. 13 depicts the Inside sheet 27 of the twin sheet door/window with the Vision Panel installed of Embodiment II.

FIG. 14 depicts the Outside sheet 29 of the twin sheet door/window with the Vision Panel installed of Embodiment II.

FIG. 15 depicts the top view of the Horizontal Cross Section of the Vision Panel Assembly of Embodiment II.

FIG. 16 depicts the side view of Vertical Cross Section of the Vision Panel Assembly of Embodiment II.

### DETAILED DESCRIPTION OF THE INVENTION

There are different ways of manufacturing the invention according to the requirements of the clients. Some of the embodiments possible are described as under.

The sheets of door/window, the frame members and the brackets may be made of any metal, plastic, fire-resistant material, wood, acoustic material or any other suitable material or a combination thereof.

The frame members may be channel members, pipe members, rod members, strip members or any other suitable members. The frame members may continually run the length of the periphery of the cutout in the door/window or may be placed at intervals around the periphery of the cutout.

The vision panel 28 may be transparent or translucent and may be made of fire-rated wired glass or fire-rated non-wired glass, regular glass, float glass, toughened glass, acrylic or any other suitable material. The vision panel could be of any size. In Embodiment II described hereunder, the dimensions of the vision panel will be larger than the smaller cutout in the outside sheet and smaller than the larger cutout in the inside sheet.

The securing means for fastening (a) the frame members together to form the frame, (b) the frame to the sheets of the door/window, (c) the brackets to the frame, (d) the strips to the brackets and (e) the nuts to the frame, may be welding, adhesion, nails, screws, ‘threaded nut and screw/bolt/Allen key assemblies’, wedging or any other suitable means. For attaching the frame to the outside sheet of the door/window and for attaching nuts to the frame members, preferably welding or adhesion may be used. Adhesion may be accomplished by using glue, adhesive tapes or very high bonding tapes or any other bonding material. As an alternative to threaded nuts, the screws/bolts/Allen keys may engage threaded apertures provided on the frame members.

Degree of inclination of the brackets may vary to suit aesthetics and the requirements of the user.

For the sake of illustration the invention is described using frame members which are ‘C’ Channel members but the invention will work equally well using pipe members, rod members, strip members or any other suitable members. Also the invention is described with frame members that run continually along the periphery of the cutout; but the invention will work just as efficiently even if the frame members are disposed at intervals along the periphery of the cutout. Further the invention is described installed in a cutout of rectangular shape but the invention with consequential adjustments if needed, will work just as competently in a cutout of any shape. The invention is also described using ‘threaded nut and screw/bolt/Allen key’ arrangements as securing means to fasten the brackets to the frame members but any other securing means will work just as well.

### EMBODIMENT I

In this embodiment of the invention the vision panel is mounted equidistant from either sheet of the twin sheet door/window.

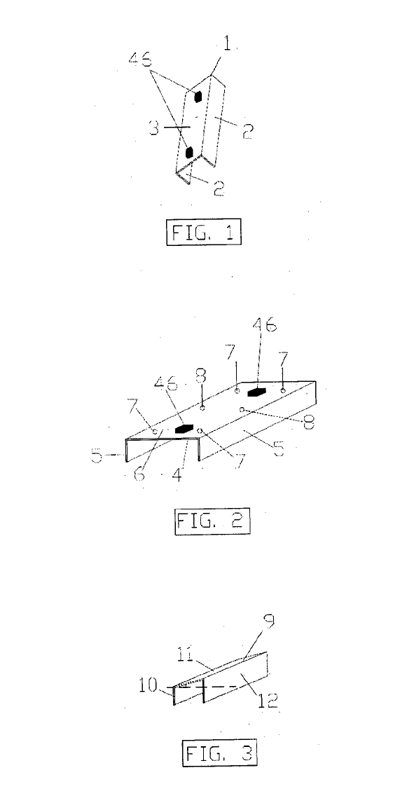

The Side Frame member 1 as depicted in FIG. 1 is ‘C’ shaped and has three sides namely, two equal sides 2 running parallel to each other and the third side 3 at about a right angle to both sides 2.

The Top and Bottom Frame member 4 as seen in FIG. 2 is ‘C’ shaped and has three sides namely, two equal sides 5 running parallel to each other and the third side 6 at about a right angle to both sides 5. Side 6 is provided with one or more ‘aperture and nuts’ arrangements 7 and 8. The nuts are attached against the aperture on the surface facing away from the vision panel, to engage with Screws/bolts/Allen keys to secure the brackets. The number of apertures and nuts increases with the increase in the height or width of the Vision Panel. The nuts 7 or 8 may be secured to the frame members by welding or sticking or any other appropriate method.

One or more stoppers/supports 46 may be provided on side 3 of frame members 1 and /or side 6 of frame member 4, on the surface facing the vision panel, to secure the vision panel in position. In this embodiment the stoppers would be placed along the longitudinal length of the frame members towards the centre of the breadth of side 3 and side 6 since the vision panel is positioned as such.

If the vision panel 28 is elongated in height or width, Side Frame members 1 may be similar to the top and bottom frame members 4 with ‘aperture and nut’ arrangements 7 and 8 through which screws/Bolts/Allen key may be screwed to secure the side brackets into the side frame members.

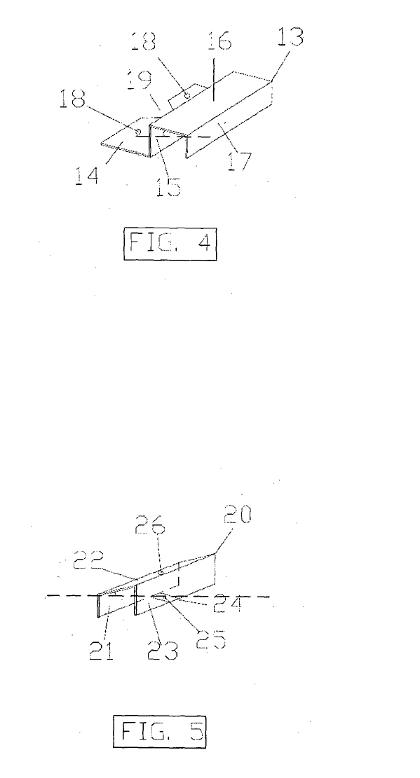

The Inside and outside side bracket 9 as depicted in FIG. 3 has 3 sides, side 10, 11 and 12. Side 10 and side 12 are parallel to one another. Side 11 may be inclined at an angle to the horizontal when measured at the point of intersection of sides 10 and 11. The angle of inclination may extend from 0° to 60° as needed. The preferred angle of inclination is 15° to 30° and the invention works optimally when the angle of inclination is 20°. The breadth of side 12 is more than the breadth of side 10 and is directly proportional to the angle of inclination of side 11. That is, the breadth of side 12 increases with the increase in the angle of inclination of side 11 and vice versa. When the angle of inclination of side 11 to the horizontal is 0°, that is when side 10 is at right angles to side 11, the breadth of side 12 is equal to the breadth of side 10.

The Top and Bottom Outside Bracket 13 as depicted in FIG. 4 has four sides 14, 15, 16 and 17. Side 14 is at about a right angle to side 15 and has one or more indentations 19 and one or more apertures 18. Side 15 and side 17 are parallel to one another. Side 16 may be inclined at an angle to the horizontal when measured at the point of intersection of sides 16 and 17. The angle of inclination may extend from 0° to 60° as needed. The preferred angle of inclination is 15° to 30° and the invention works optimally when the angle of inclination is 20°. The breadth of side 15 is more than the breadth of side 17 and is directly proportional to the angle of inclination of side 16. That is, the breadth of side 15 increases with the increase in the angle of inclination of side 16 and vice versa. When the angle of inclination is 0°, that is when side 15 is at right angles to side 16, the breadth of side 15 is equal to the breadth of side 17. Top and Bottom Outside Bracket 13 may have increased numbers of indentations 19 and apertures 18 as the vision panel increases in height or width in order to provide for screws/bolts/Allen keys to secure the brackets to the frame. In cases where the brackets are welded or stuck to the frame members to provide maximum security and strength and save on cost of nut and Screw/Bolt/Allen key assemblies, the, Top and bottom outside brackets 13 may also be constructed without side 14 and will be similar to side brackets 9.

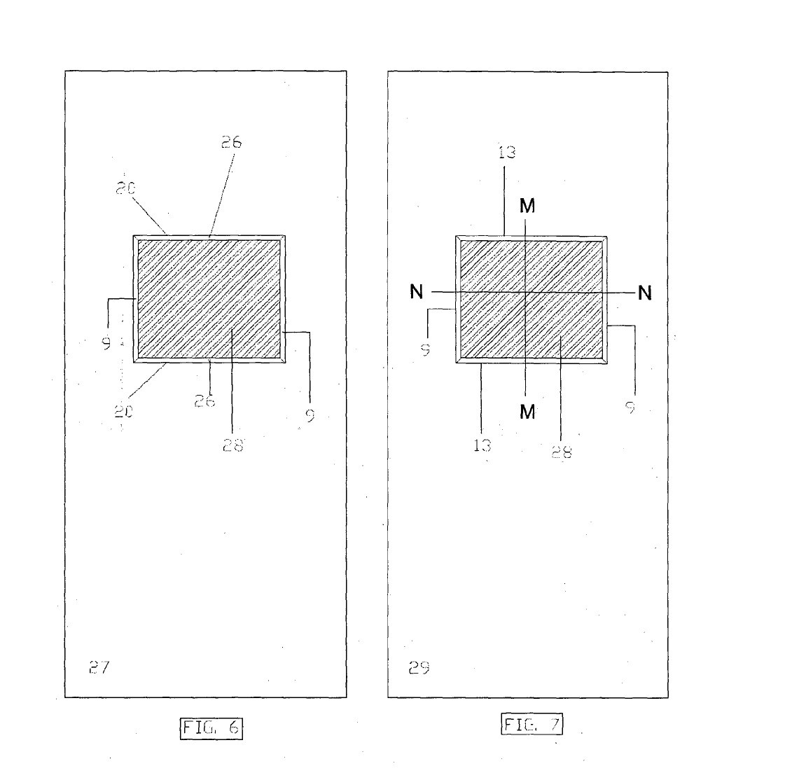

The Top and Bottom Inside Bracket 20 as depicted in FIG. 5 has 3 sides, side 21, side 22 and side 23. Side 21 and side 23 are parallel to one another. Side 22 may be inclined at an angle to the horizontal when measured at the point of intersection of sides 21 and 22. The angle of inclination may extend from 0° to 60° as needed. The preferred angle of inclination is 15° to 30° and the invention works optimally when the angle of inclination is 20°. The breadth of side 23 is more than the breadth of side 21 and is directly proportional to the angle of inclination of side 22. That is, the breadth of side 23 increases with the increase in the angle of inclination of side 22 and vice versa. When the angle of inclination is 0°, that is when side 22 is at right angles to side 23, the breadth of side 23 is equal to the breadth of side 21. This bracket may also be provided with one or more strips 24 secured to the brackets preferably by welding or adhesion, the said strips having one or more apertures 25. The strips 24 connect the edges of side 21 and side 23. Side 22 is provided with one or more apertures 26 which are positioned so that Screw/Bolt/Allen keys can be screwed into aperture 26 through the aperture 25 into ‘aperture and nuts’ 8. Top and bottom inside brackets may have increased number of combination of strips and apertures 24, 25 and 26 as the vision panel increases in height or width; in order to fasten the brackets and the vision panel more securely to the frame.

If the vision panel is elongated in length, inside and outside side brackets 9 may be similar to the top and bottom inside bracket 20, provided with one or more combinations of strips and apertures like 24, 25 and 26 or may be similar to top and bottom outside brackets 13 having side 14 with apertures 18 and indentations 19; in order to fasten the brackets and the vision panel more securely to the frame.

FIG. 6 depicts the Inside sheet 27 of the twin sheet door with the Vision Panel 28 installed. Side 22 of the Top and Bottom Inside brackets 20 and side 11 of the Inside side brackets 9 are visible. Also visible is the aperture 26 in the Top and Bottom Inside brackets 20 through which the Screw/Bolt/Allen key 30 is screwed in order to fasten/secure the brackets to the frame members of the frame.

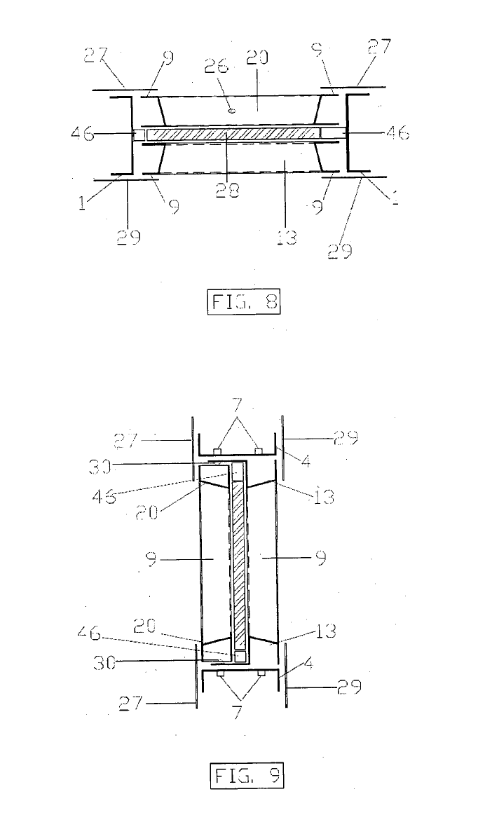

FIG. 7 depicts the Outside sheet 29 of the twin sheet door/window with the Vision Panel 28 installed. Side 16 of the Top and Bottom Outside brackets 13 and side 11 of the outside side brackets 9 are visible. M-M depicts the vertical direction and N-N depicts the horizontal.

FIG. 8 depicts the top view of the Horizontal Cross Section of the Vision Panel Assembly. The vision panel 28 is depicted to be held in position by the Inside and outside side brackets 9 and stoppers 46 provided on the frame members, the Top and Bottom Inside brackets 20 and the Top and Bottom Outside brackets 13 all of which are fitted into the frame. Side frame member 1 is visible, secured within the twin sheet door/window having Inside sheet 27 and Outside sheet 29. The aperture 26 in the Top and Bottom Inside brackets 20 through which the Screw/Bolt/Allen key 30 is screwed in order to fasten the brackets to the nuts 8 of the frame members is also shown.

FIG. 9 shows the side view of Vertical Cross Section of the Vision Panel Assembly. The vision panel 28 is shown to be held in position by the Inside and outside side brackets 9, the top and bottom outside brackets 13 and the Top and Bottom Inside brackets 20 all of which are fitted into the frame. Top and Bottom frame members 4 are visible, secured within the twin sheet door/window having Inside sheet 27 and Outside sheet 29. The nuts 7 in the Top and Bottom frame members engage with the Screw/Bolt/Allen key 30 which are screwed through aperture 18 of the top and bottom outside brackets 13 in order to fasten the brackets to the door/window is also shown.

Additionally, the brackets may be constructed without the side juxtaposed against the sheets of the door/window, that is without, side 10 of the inside and outside side bracket 9, side 17 of the top and bottom outside bracket 13 and Side 21 of the top and bottom inside bracket 20 or a combination of brackets may be used where some brackets have a side juxtaposed against the sheets of the door/window and the others do not.

### EMBODIMENT II

In a second embodiment of the invention the vision panel is installed to one side of the vision panel assembly resting against the cutout in the Inside sheet of the twin sheet door/window as depicted in FIGS. 15 and 16.

The Side Frame member is the same as side frame member 1 as shown in FIG. 1.

The Top and Bottom Frame member 31 as seen in FIG. 10 is ‘C’ shaped and has three sides namely, two equal sides 32 parallel to one another and the third side 33 which is at about a right angle to both sides 32. Side 33 has one or more ‘aperture and nut’ arrangements 34 on its inner side to receive the Screws/Bolts/Allen Keys to fix the brackets in position into the frame. The number of nuts 34 increases with the increase in height or width of the Vision Panel. The nuts 34 may be secured to the frame members by welding or sticking or any other appropriate method. Nuts are fixed against the aperture, to the frame members, on the surface facing away from the vision panel.

One or more stoppers/supports 46 may be provided on side 3 of frame members 1 and/or side 33 of frame member 31, on the surface facing the vision panel, to secure the vision panel in position. In this embodiment the stoppers would be placed along the longitudinal length of the frame members towards the edge of the breadth of side 3 and side 33 since the vision panel is positioned as such.

If the vision panel 28 is elongated in length, Side Frame members 1 may be similar to the top and bottom frame members 31 with ‘aperture and nut’ arrangements 34 through which Screw/Bolt/Allen keys may be screwed to secure the side brackets into the side frame members.

The Inside side bracket 35 as depicted in FIG. 11 has 3 sides, side 36, side 37 and side 38. Side 36 and side 38 are parallel to one another. Side 37 may be inclined at an angle to the horizontal when measured at the point of intersection of sides 37 and 38. The angle of inclination may extend from 0° to 60° as needed. The preferred angle of inclination is 15° to 30° and the invention works optimally when the angle of inclination is 20°. The breadth of side 36 is more than the breadth of side 38 and is directly proportional to the angle of inclination of side 37. That is the breadth of side 36 increases with the increase in the angle of inclination of side 37 and vice versa. When the angle of inclination is 0°, that is side 36 is at right angles to side 37, the breadth of side 36 is equal to the breadth of side 38.

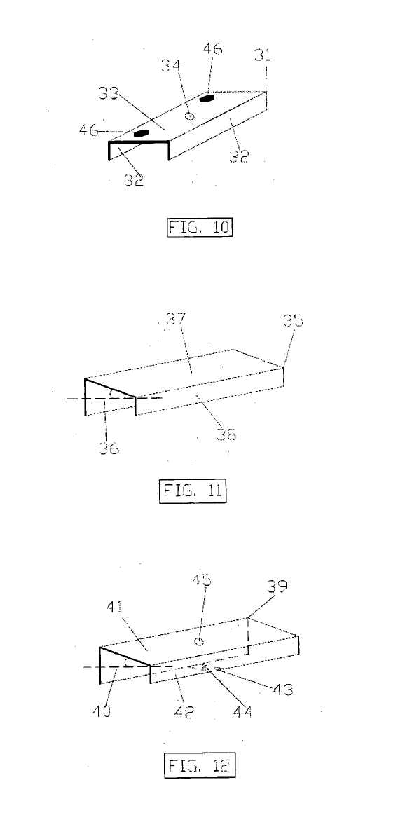

The Top and Bottom Inside Bracket 39 as shown in FIG. 12 has 3 sides, side 40, side 41 and side 42. Side 40 and side 42 are parallel to one another. Side 41 may be inclined at an angle to the horizontal when measured at the point of intersection of sides 41 and 42. The angle of inclination may extend from 0° to 60° as needed. The preferred angle of inclination is 15° to 30° and the invention works optimally when the angle of inclination is 20°. The breadth of side 40 is more than the breadth of side 42 and is directly proportional to the angle of inclination of side 41. That is the breadth of side 40 increases with the increase in the angle of inclination of side 41 and vice versa. When the angle of inclination is 0°, that is side 40 is at right angles to side 41, the breadth of side 40 is equal to the breadth of side 42. The top and bottom inside bracket 39 may also be provided with one or more strips 43, secured to the brackets preferably by welding or adhesion, having one or more apertures 44. The strips 43 connect the edges of side 40 and side 42. Side 41 is provided with one or more apertures 45 which are positioned so that Screw/Bolt/Allen keys can be screwed through apertures 45 and 44 into ‘aperture and nut’ arrangements 34. Top and bottom inside brackets 39 may have increased number of combination of strips and apertures 43, 44 and 45 as the dimensions of the vision panel increases in height or width.

Inside side brackets 35 may be provided with one or more combinations of strips and apertures like 43, 44 and 45 of the top and bottom inside bracket 39, if vision panel is elongated in length; in order to fasten the brackets and the vision more securely to the frame.

If the vision panel is elongated in height, inside and outside side brackets 9 may be similar to the top and bottom inside bracket 20, provided with one or more combinations of strips and apertures like 24, 25 and 26 or may be similar to top and bottom outside brackets 13 having side 14 with apertures 18 and indentations 19; in order to fasten the brackets and the vision panel more securely to the frame.

FIG. 13 shows the Inside sheet 27 of the twin sheet door/window with the Vision Panel 28 installed. Side 41 of the Top and Bottom brackets 39 and side 37 of the Inside side brackets 35 are visible. Also visible is the aperture 45 in the Top and Bottom Inside brackets 39 through which the Screw/Bolt/Allen key 30 is screwed in order to secure the brackets to the frame.

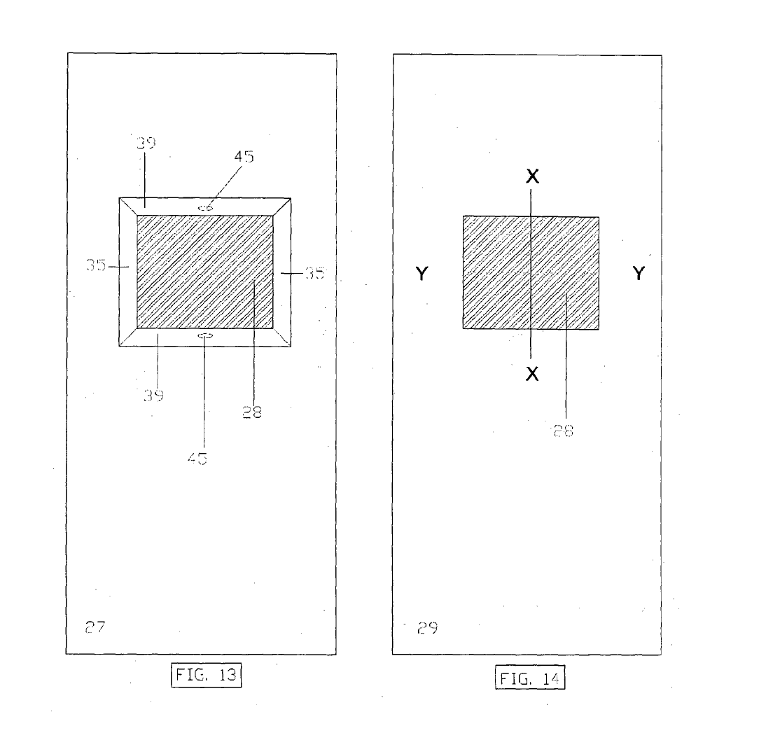

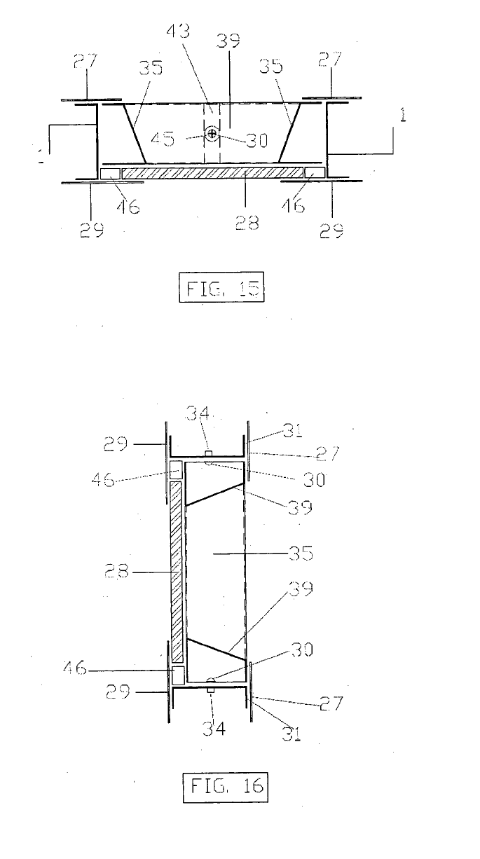

FIG. 14 shows the Outside sheet 29 of the twin sheet door/window with the Vision Panel installed. Only the vision panel 28 is visible in the cutout made in the door/window. X-X shows the vertical direction and Y-Y depicts the horizontal.

FIG. 15 shows the top view of the Horizontal Cross Section of the Vision Panel. The vision panel 28 is shown to be held in position against the cutout in the Outside sheet 29 with the help of the Inside side brackets 35 and the Top and Bottom Inside brackets 39 all of which are fitted into the frame. Side frame member 1 is visible, secured within the twin sheet door/window having Inside sheet 27 and Outside sheet 29. The strip 43 of top and bottom inside bracket 39 is also shown. The aperture 45 in the Top and Bottom Inside brackets 39 through which the Screw/Bolt/Allen key 30 is screwed into the aperture 44 in strip 43 in order to fasten the brackets to nuts 34 of the top and bottom frame member 31 is also illustrated.

FIG. 16 depicts the side view of Vertical Cross Section of the Vision Panel. The vision panel 28 is shown to be held in position against the cutout provided in the Outside sheet 29 with the help of the Inside side brackets 35 and the Top and Bottom Inside brackets 39 all of which are fitted into the frame. Top and Bottom frame members 31 are visible, secured within the twin sheet door/window having Inside sheet 27 and Outside sheet 29. The ‘apertures and nuts’ 34 in the Top and Bottom frame members into which the screw/bolt/Allen key 30 is screwed in order to fasten the brackets to the frame is also shown. Stoppers 46 of the side frame member 1 and 31 provided to secure the vision panel 28 in position are shown.

In this embodiment the vision panel 28 is smaller in area than the cutout in the inside sheet 27 and bigger than the cutout in the outside sheet 29.

Additionally, the brackets may be constructed without the side juxtaposed against the sheets of the door/window, that is without side 38 of the inside side brackets 35 and/or without the side lying upon the top and bottom frame members, that is, without Side 42 of the top and bottom inside bracket 39 or a combination of brackets may be used, where some brackets have a side juxtaposed against the sheets of the door/window and/or the side lying upon the top and bottom frame members while the others do not.

### METHOD OF INSTALLING THE VISION PANEL ASSEMBLY

### Embodiment I

In this embodiment of the invention the vision panel assembly is installed with the vision panel mounted equidistant from either sheet of the twin sheet door/window as seen in FIGS. 1 to 9.

Cutouts of equal size are to be made in the inside sheet 27 and outside sheet 29 of the twin sheet door/window. The size of the frame will be in accordance with the size of the cutout in the sheets of door/window.

The two Side frame members 1 are welded, screwed, stuck or attached by any other suitable securing means to the top and bottom frame members 4 in order to complete the formation of the frame. The longitudinal edges of sides of the frame members face away from the periphery of the cutout. The top and bottom frame members 4 are disposed between the side frame members 1. Edges of the breadth of sides 5 and 6 of the top and bottom frame members 4 will be positioned on side 3 of the side frame member 1, at the top and bottom end of the side frame members 1 respectively to form the frame.

This Frame is fixed on the inside of either sheet of the twin sheet door/window using securing means. Preferably welding or adhesion is used to attach the frame to the door/window. The frame is fixed away from the peripheral edge of the cutout but in close proximity to it. The distance at which frame is fixed away from the peripheral edge of the cutout depends on the breadth of the side juxtaposed against the sheet of the door/window. That is, the distance depends on the breadth of side 10 of the inside and outside side bracket 9, side 17 of the top and bottom outside bracket 13 and Side 21 of the top and bottom inside bracket 20. When the brackets are constructed without a side juxtaposed against the sheet of the door/window, that is, without sides 10, 17 and 21, the distance at which the frame is fixed away from the periphery of the cutout depends on the thickness of the material of the brackets.

The second sheet of the twin sheet door/window is then positioned/slid over the frame so that the cutouts are in alignment with each other. The sheet may then be secured to the frame by a process similar to that used for securing the frame to the first sheet of the twin sheet door/window. The sheets when fitted to the frame are juxtaposed against sides 2 of the side frame members 1 and sides 5 of the top and bottom frame members 4.

Both outside side brackets 9 are then placed vertically in position into both the side frame members 1. The longitudinal edges of Sides 10 and 12 of the outside side bracket 9 will be resting against side 3 of the side frame member 1. Side 10 will be juxtaposed against outside sheet 29.

Next, the top and bottom outside brackets 13 will be fitted respectively into the top and bottom frame members 4 of the frame. Edges of sides 15, 16 and 17 of the top and bottom outside bracket 13 will be resting against side 11 of the outside side brackets 9.

Side 17 of the top and bottom outside brackets 13 will be juxtaposed against outside sheet 29 and side 15 will be juxtaposed against the outer side of the vision panel 28. Side 14 will lie upon side 6 of the top and bottom frame members 4 respectively. The top and bottom outside brackets 13 will be fastened into the frame by screwing Screw/Bolt/Allen keys (30) into ‘apertures and nuts’ (7) provided in the top and bottom frame members 4 respectively through the apertures (18) provided in the top and bottom brackets 13.

The vision panel 28 is then inserted through the cutout in the inside sheet 27 of the door/window. Vision panel is to be positioned resting against the top and bottom outside brackets 13. The horizontal edges of the vision panel are wedged between side 14 of the top and bottom outside brackets 13. The vision panel 28 leans against side 15 of the top and bottom outside brackets 13 and side 12 of the outside side bracket 9. The vision panel may be supported by stoppers (46) of suitable size provided on the frame members 1 and 4.

Through the cutout in the inside sheet 27 of the twin sheet door/window, inside side brackets 9 are then wedged vertically in position into both the side frame members 1. The longitudinal edges of Sides 10 and 12 of the inside side bracket 9 will be resting against side 3 of the side frame member 1. Side 10 of the inside side bracket 9 will be juxtaposed against the inside sheet 27 and side 12 will be juxtaposed against the vision panel 28.

Therefore the vision panel 28 is held in position by side 15 of the top and bottom outside brackets 13 and side 12 of the inside and outside side brackets 9.

The vision panel assembly is then completed by fitting the Top and Bottom inside brackets 20 on the top and bottom frame members 4 respectively, between the two inside side brackets 9 as seen in FIG. 6. Edges of sides 21, 22 and 23 of the top and bottom inside brackets 20 will be resting against side 11 of the outside side brackets 9. Side 23 of the top and bottom inside brackets 20 will be placed against vision panel 28 and side 21 against the inside sheet 27. Screw/Bolt/Allen key 30 are then screwed through the apertures 26 of the top and bottom inside brackets 20, pass through apertures 25 provided in the strips 24 of the brackets into the ‘apertures and nuts’ 8 in the top and bottom frame members 4. The apertures 25 on the strips 24 are aligned with the indentations 19 of the top and bottom outside brackets 13.

The completely assembled vision panel assembled according to this embodiment and installed in a twin sheet door/window can be seen in FIG. 6-9. As can be seen, only the angled sides 11, 16 and 22 of the brackets are on display and all the other sides are completely hidden from view; giving the installation an aesthetic look.

If the outside sheet of the door/window is identified beforehand, then irrespective of the size of the vision panel, the brackets may be welded or stuck into position to yield maximum security and strength. In such case, top and bottom outside brackets 13 may be constructed without side 14 and will be similar to side brackets 9.

### Embodiment II

In a second embodiment of the invention shown in FIG. 1 and FIG. 10-16, the vision panel assembly is installed with the vision panel to one side of the vision panel assembly against the Outside sheet of the twin sheet door/window as seen in FIG. 15-16.

Cutouts of unequal size are to be made in the inside sheet 27 and outside sheet 29 of the twin sheet door/window. The outside sheet 29 of the door/window will have a smaller cut out than the cut out on the inside sheet of the door/window 27. The size of the frame will be in accordance with the size of the cutout in the inside sheet of the door/window.

The two Side frame members 1 are welded, screwed stuck or attached by any other suitable method to the top and bottom frame members 31 in order to complete the formation of the frame. The longitudinal edges of sides of the frame members face away from the periphery of the cutout. The top and bottom frame members 31 are disposed between the side frame members 1. Edges of the breadth of sides 32 and 33 of the top and bottom frame members 31 will be placed resting on side 3 of the side frame member 1, at the top and bottom end of the side frame members 1 respectively to form the frame.

This Frame is fixed on the inside of either sheet of the twin sheet door/window using securing means, preferably on the inside sheet 27 of the twin sheet door/window. Preferably welding or adhesion is used to attach the frame to the door/window. The frame is fixed away from the peripheral edge of the cutout but in close proximity to it. The distance at which frame is fixed away from the peripheral edge of the cutout depends on the breadth of the side juxtaposed against the sheet of the door/window, that is the breadth of side 38 of the inside side brackets 35 and Side 42 of the top and bottom inside bracket 39. When the brackets do not have a side juxtaposed against the sheet of the door/window, that is without side 38 of the inside side brackets 35 and Side 42 of the top and bottom inside bracket 39, the distance at which the frame is fixed away from the periphery of the cutout depends on the thickness of the material of the brackets.

The second sheet 29 of the twin sheet door/window is then positioned/slid over the frame. The sheet may then be secured to the frame by a process similar to that used for securing the frame to the inside sheet 27 of the twin sheet door/window. Both sheets when fitted to the frame are juxtaposed against sides 38 of the inside side bracket 35 and sides 42 of the top and bottom inside brackets 39.

The vision panel 28 is then inserted through the cutout in the inside sheet 27 of the door/window. Vision panel is to be placed resting against the smaller cutout provided in the outside sheet 29. The vision panel may be supported by stoppers (46) of suitable size provided in the frame members 1 and 31.

Through the cutout in the inside sheet 27 of the twin sheet door/window, inside side brackets 35 are then placed vertically in position into both the side frame members 1. The longitudinal edges of sides 36 and 38 of the inside side bracket 35 will be resting against side 3 of the side frame member 1. Side 38 of the inside side bracket 35 will be juxtaposed against the inside sheet 27 and side 36 will be juxtaposed against the vision panel 28.

The vision panel assembly is then completed by fitting the Top and Bottom inside brackets 39 on the top and bottom frame members respectively, of the frame, between the two inside side brackets 35 as seen in FIGS. 15 and 16. Edges of sides 40 and 42 will be resting against side 33 of the top and bottom frame members 31. Side 40 will be positioned against vision panel 28 and side 42 against the inside sheet 27 as seen in FIGS. 15 and 16. Screw/Bolt/Allen key (30) are then screwed through the apertures 45 of the top and bottom inside brackets 39, pass through apertures 44 provided in the strips 43 of the brackets into the ‘apertures and nuts’ (34) in the top and bottom frame members 31.

The completely assembled vision panel assembled according to this embodiment and installed in a twin sheet door/window can be seen in FIG. 13-16. As can be seen only the angled sides 37 and 41 of the brackets are on display and all the other sides are completely hidden from view; giving the installation an aesthetic look.

This invention is not necessarily restricted to the particular embodiments presented herein but the scope of the invention is to be defined by the terms of the following claims as given meaning by the preceding description.

1. A vision panel assembly mounted in a cutout in a twin-sheet door or window comprising:
a frame adapted to be mounted in said cutout comprising:
side frame members disposed along the side peripheries of said cutout; and
top and bottom frame members disposed along the top and bottom periphery of said-cutout;
brackets adapted to be mounted in said frame including:
a top and a bottom inside bracket;
a top and a bottom outside bracket;
two inside side brackets and;
two outside side brackets;
a vision panel disposed in said frame and;
securing means to fasten the vision panel assembly and provide a tamper-proof arrangement.

2. The vision panel assembly as claimed in claim 1 wherein the frame members are channel members, pipe members, rod members, or strip members.

3. The vision panel assembly as claimed in claim l wherein said frame members are provided with one or more stoppers on a surface facing the vision panel, to secure the vision panel in position.

4. The vision panel assembly as claimed in claim 1 wherein the securing means utilized to fasten:
the frame members to form the frame;
the frame to the sheets of the twin sheet door/window;
the brackets to the frame;
the strips to the brackets; and
the nuts to the frame members,
are welding, adhesion, screw elements, nails, threaded nut and screw, threaded nut and bolt, threaded nut and Allen key, or wedging, of which the said threaded nut and screw, threaded nut and bolt, threaded nut and Allen key engage through apertures provided in the brackets, strips and frame members with corresponding nut elements provided on the frame members to fasten the brackets to the frame members.

5. The vision panel assembly as claimed in claim 4 wherein the said frame members are provided with:
one or more threaded apertures; or
one or more apertures with corresponding nuts attached to the frame members against the apertures, on a surface facing away from the vision panel,
through which the threaded nut and screw, threaded nut and bolt, threaded nut and Allen key fasten the brackets to the frame.

6. The vision panel assembly as claimed in claim 1 wherein the inside and outside side brackets and the top and bottom inside brackets are constructed with a first side juxtaposed against the vision panel, a second angled side and a third side parallel to the first side and juxtaposed against the sheet of the twin sheet door or window.

7. The vision panel assembly as claimed in claim 1 wherein the top and bottom outside brackets are constructed with a first side lying upon the top and bottom frame members respectively, a second side juxtaposed against the vision panel, a third angled side and a fourth side juxtaposed against the outside sheet of the twin sheet door or window.

8. The vision panel assembly as claimed in claim 7 wherein the first side is provided with one or more indentations.

9. The vision panel assembly as claimed in claim 8 wherein the first side is provided with one or more apertures.

10. The vision panel assembly as claimed in claim 6 wherein the second angled side is provided with one or more apertures.

11. The vision panel assembly as claimed in claim 6 wherein the brackets are provided with one or more strips connecting the edges of the sides of the brackets, the said strips having one or more apertures, the said apertures being in alignment with the apertures on the angled side of the brackets and with the apertures on the frame.

12. The vision panel assembly as claimed in claim 1 wherein one or more brackets are constructed:
without a side juxtaposed against the sheet of the twin sheet door or window; or without a side lying upon the top and bottom frames.

13. The vision panel assembly as claimed in claim 6 wherein an angle of inclination of the angled side of the brackets to the horizontal is in the range of 0° to 60°.

14. The vision panel assembly as claimed in claim 13 wherein the angle of inclination of the angled side of the brackets to the horizontal is in the range of 15° to 30°.

15. The vision panel assembly as claimed in claim 14 wherein the angle of inclination of the angled side of the brackets to the horizontal is 20°.

16. The vision panel assembly as claimed in claim 1 wherein the vision panel is transparent or translucent and is made of fire-rated wired glass or tire-rated non-wired glass, regular glass, float glass, toughened glass, or acrylic.

17. The vision panel assembly as claimed in claim 1 wherein the frame members and brackets are made of metal, plastic, fire-resistant material, wood, or acoustic material.

18. A method of installing the vision panel assembly of claim 1 comprising the steps of:
Making cutouts of a desired shape of equal or unequal dimensions on both sheets of the twin sheet door/window; and
Securing the frame, brackets and vision panel into position.

19. The method as claimed in claim 18 wherein when the cutouts are of equal dimensions the method further comprises of the steps of:
securing the frame members on the inner surface of either sheet of the twin sheet door or window along a periphery of the cutout but away from the periphery to form a frame wherein the frame members continually run an entire length of the periphery of the cutout in the door or window or are placed at intervals along the periphery of the cutout;
placing the second sheet of the twin sheet door or window over the frame and fixing it to the frame;
securing the outside side brackets in position into the frame;
securing the top and bottom outside brackets into the frame, in between the outside side brackets;
inserting the vision panel through the cutout in the sheet of the door/window and placing it on the frame to rest against the outside side brackets and top and bottom outside brackets;
securing the inside side brackets into position into the frame; and
securing the inside top and bottom brackets into the frame, in between the inside side brackets.

20. The method as claimed in claim 18 wherein when the cutouts are of unequal dimensions the method further comprises of the steps of:
making a larger cutout in the inside sheet of the twin sheet door or window and a smaller cutout in the outside sheet, such that dimensions of the larger cutout is larger than dimensions of the vision panel and the dimensions of the smaller cutout is smaller than the dimensions of the vision panel;
securing the frame members on the inner surface of either sheet of the twin sheet door or window, along a periphery of the cutout but away from the periphery to form a frame wherein the frame members continually run an entire length of the periphery of the cutout in the door or window or are placed at intervals along the periphery of the cutout;
placing the second sheet of the twin sheet door or window over the flame and securing it to the frame;
inserting the vision panel through the larger cutout on the inner sheet of the door or window and placing it on the frame, resting against the outer sheet of the door or window; securing the inside side brackets into the frame to secure the vision panel in position; and
securing the inside top and bottom brackets into the frame, in between the inside side brackets.

21. The method as claimed in claim 19 wherein:
when the brackets have a side juxtaposed against the sheet of the door or window, a distance at which the frame is fixed away from the periphery of the cutout depends on the breadth of the side juxtaposed against the sheet of the door or window; and
when the brackets do not have a side juxtaposed against the sheet of the door or window, the distance at which the frame is fixed away from the periphery of the cutout depends on the thickness of the material of the brackets.

22. (canceled)

23. The vision panel assembly as claimed in claim 7 wherein the third angled side is provided with one or more apertures.

24. The vision panel assembly as claimed in claim 7 wherein the brackets are provided with one or more strips connecting the edges of the sides of the brackets, the said strips having one or more apertures, the said apertures being in alignment with the apertures on the third angled side of the brackets and with the apertures on the frame.

25. The method as claimed in claim 20 wherein:
when the brackets have a side juxtaposed against the sheet of the door or window, a distance at which the frame is fixed away from the periphery of the cutout depends on a breadth of the side juxtaposed against the sheet of the door or window; and
when the brackets do not have a side juxtaposed against the sheet of the door or window, the distance at which the frame is fixed away from the periphery of the cutout depends on a thickness of the material of the brackets.
